(19) United States
(12) Patent Application Publication
(10) Pub. No.: US 2024/0413568 A1
(43) Pub. Date: Dec. 12, 2024

(54) SEALED CONNECTOR ASSEMBLY WITH COMBINATION CONNECTOR SEAL

(71) Applicant: Aptiv Technologies AG, Schaffhausen (CH)

(72) Inventors: Adam WOLFGANG, Petersburg, OH (US); William STRANG, Newton Falls, OH (US); Charles FLASK, Warren, OH (US); Terry GEORGE, Salem, OH (US)

(21) Appl. No.: 18/734,265

(22) Filed: Jun. 5, 2024

Related U.S. Application Data
(60) Provisional application No. 63/471,835, filed on Jun. 8, 2023.

(51) Int. Cl. H01R 13/52

(52) U.S. Cl. CPC H01R 13/5202

(57) ABSTRACT

A sealed connector assembly may include a compliant perimeter seal having a seal side wall, a seal end wall extending from a first end of the seal side wall in a first direction, and a seal lip extending from a second end of the seal side wall in a second direction opposite the first direction. The seal side wall defines a sealing rib. The sealed connector assembly may include a connector housing, further including an outer portion having a perimeter wall with a side segment and an end segment. The seal side wall abuts the side segment, and the seal end wall abuts the end segment. The seal lip overlays an end of the side segment of the perimeter wall. An inner portion disposed inside the perimeter wall has a connector lip that overlies the seal lip and an end of the side segment of the perimeter wall.

### CROSS-REFERENCE TO RELATED APPLICATIONS

This application claims the benefit of and priority to U.S. Provisional Application 63/471,835, titled “Scaled Connector Assembly with Combination Connector Seal”, filed Jun. 8, 2023, the contents of which are incorporated by reference herein.

### TECHNICAL FIELD

This disclosure is directed to a sealed connector assembly, particularly to a sealed connector assembly with a combination connector seal suited for use with automotive electrical connectors.

### BACKGROUND

Existing sealed connector assemblies are prone to causing variations in engagement force of the connector system due to small variations in the connector seal gap and/or the seal's material characteristics, especially oil bleed materials. Current seals used in sealed connector assemblies are also susceptible to bunching, pinching, and/or rolling when the separate connector housings of the connector assembly are mated together.

Previous approaches to sealed connector assemblies have typically involved utilizing various types of seals and housings to prevent the ingress of contaminants and moisture into the connector interface. These approaches have included the use of O-rings, gaskets, and other sealing elements to create a barrier between the connector components and the external environment.

While these traditional sealing methods have been effective to some extent, they often require complex assembly processes and may not provide a completely secure seal over time due to wear and degradation of the sealing materials.

In some instances, connector housings have been designed with integrated sealing features to improve the overall sealing performance of the assembly. These integrated seals have been implemented to create a more robust barrier against environmental factors and to enhance the reliability of the connector interface. However, these integrated seals have typically been limited in their design and functionality, often lacking the flexibility and adaptability needed to accommodate variations in connector configurations and environmental conditions.

Additionally, efforts have been made to develop connector assemblies with improved sealing capabilities by optimizing the interaction between the seal and the housing components. These efforts have focused on enhancing the sealing effectiveness of the connector assembly by ensuring proper alignment and engagement of the seal with the housing elements. Despite these advancements, challenges remain in achieving a sealed connector assembly that offers both reliable sealing performance and case of assembly. However, none of these approaches have provided a comprehensive solution that combines the features described in this disclosure.

### SUMMARY

In some aspects, the techniques described herein relate to a sealed connector assembly, including: a compliant perimeter seal having a seal side wall, a seal end wall extending from a first end of the seal side wall in a first direction, and a seal lip extending from a second end of the seal side wall in a second direction opposite the first direction; and a connector housing, further including: an outer portion having a perimeter wall which defines a side segment and an end segment, the seal side wall abutting the side segment and the seal end wall abutting the end segment and the seal lip overlaying at least a portion of an end of the side segment of the perimeter wall, and an inner portion disposed inside the perimeter wall, the inner portion having a connector lip that overlies at least a portion of the seal lip and at least a portion of an end of the side segment of the perimeter wall.

In some aspects, the techniques described herein relate to a method of manufacturing a sealed connector assembly, including: inserting a compliant perimeter seal within an outer portion of a first connector housing, the perimeter seal having a seal side wall, a seal end wall extending from a first end of the seal side wall in a first direction, and a curved seal lip extending from a second end of the seal side wall in a second direction opposite the first direction, the outer portion having a perimeter wall defining a side segment and an end segment; abutting the seal side wall against the side segment; abutting the seal end wall against the end segment; overlaying the seal lip over an end of the side segment of the perimeter wall; and inserting an inner portion of the first connector housing within a perimeter wall of the outer portion, the inner portion having a connector lip that overlies the seal lip and an end of the side segment of the perimeter wall; capturing the seal lip between the connector lip and the end of the side segment of the perimeter wall to retain the perimeter seal to the first connector housing.

### BRIEF DESCRIPTION OF THE DRAWINGS

Embodiments of the present invention will now be described by way of example with reference to the accompanying drawings, in which:

FIG. 1 is an isometric view of a sealed connector assembly according to some embodiments.

FIG. 2 is an exploded view of the sealed connector assembly of FIG. 1 according to some embodiments.

FIG. 3A is an isolated isometric view of a connector housing seal of the sealed connector assembly of FIG. 1 according to some embodiments.

FIG. 3B is a cross-section view of the connector housing seal of FIG. 3A according to some embodiments.

FIG. 3C is a close-up view of FIG. 3B according to some embodiments.

FIG. 4 is a cross section end view of the sealed connector assembly of FIG. 1 according to some embodiments.

FIG. 5 is a close up view of the cross section end view of FIG. 4 according to some embodiments.

FIG. 6 is a flow chart of a method of manufacturing a sealed connector assembly according to some embodiments.

### DETAILED DESCRIPTION

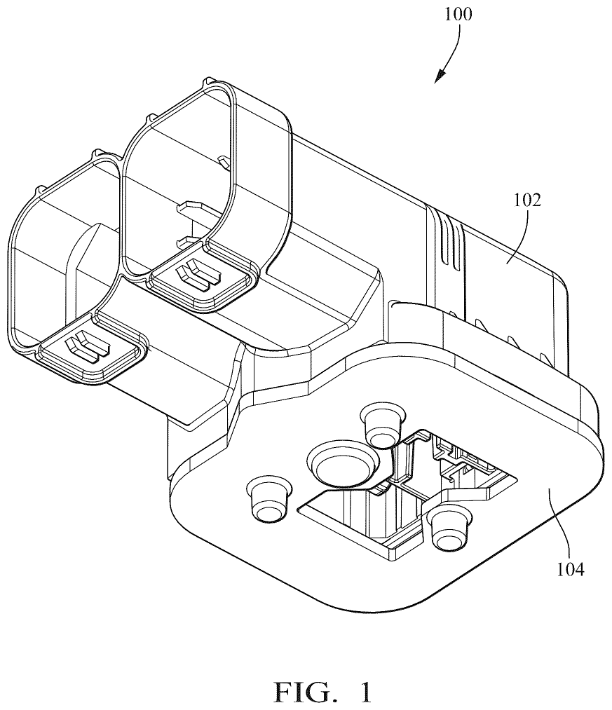

FIG. 1 shows a non-limiting example of a sealed connector assembly 100. While the example presented herein is directed to a sealed electrical connector assembly, alternative embodiments of the connector may be envisioned that are configured to interconnect fiber optic cables, pneumatic tubes, hydraulic tubes, or a hybrid sealed connector having a combination of any of these types of conductors. As shown in FIG. 1, the sealed connector assembly 100 includes a first connector housing 102 which is configured to be mated with a second connector housing 104. In the illustrated example, the first connector housing is made of a polymeric material, such as polyamide (NYLON) or polybutylene terephthalate (PBT), the polymeric material may or may not be glass-filled. In the illustrated example, the second connector housing 104 is made of a metallic material, such as aluminum and may integrally formed with another component, such as a battery pack of an electric vehicle. Other embodiments of the sealed connector assembly 100 may be envisioned in which the first and second connector housings 102, 104 are formed of other suitable materials.

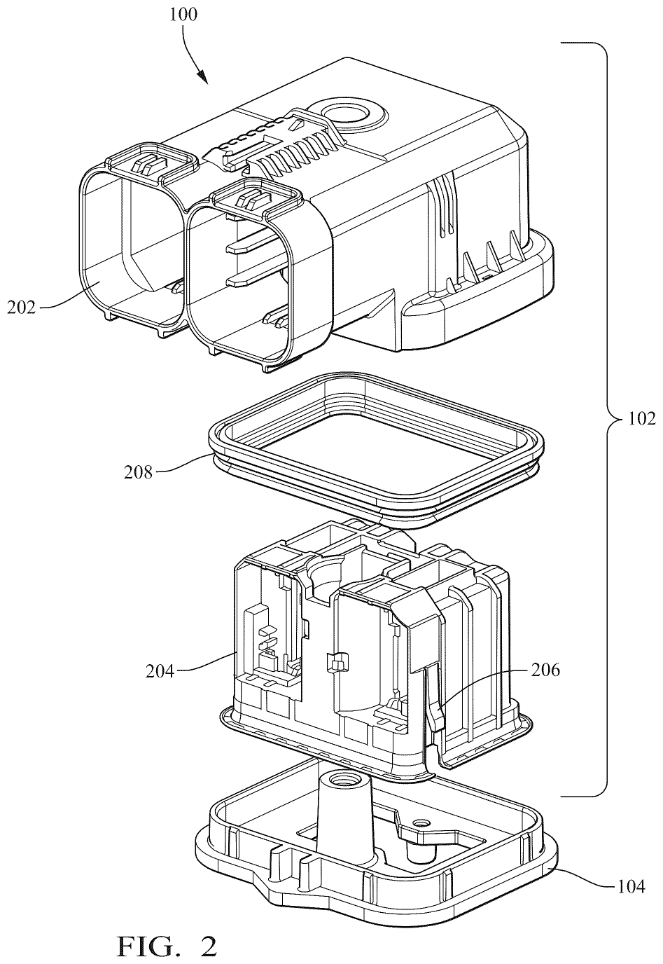

FIG. 2 shows an exploded view of the sealed connector assembly 100. The first connector housing 102 includes an outer portion 202 and an inner portion 204 that may be disposed within the outer portion 202. The inner portion 204 defines one or more flexible arms 206 that releasably secure the inner portion 204 within the outer portion 202. The first connector housing 102 also includes a connector housing seal in the form of a compliant perimeter seal 208 that is disposed between the outer portion 202 and the inner portion 204 of the first connector housing 102. The perimeter seal 208 is formed of a compliant elastomeric material, such as an oil-bleeding silicone rubber, e.g., Dow SILASTIC® 9201-50-LSR.

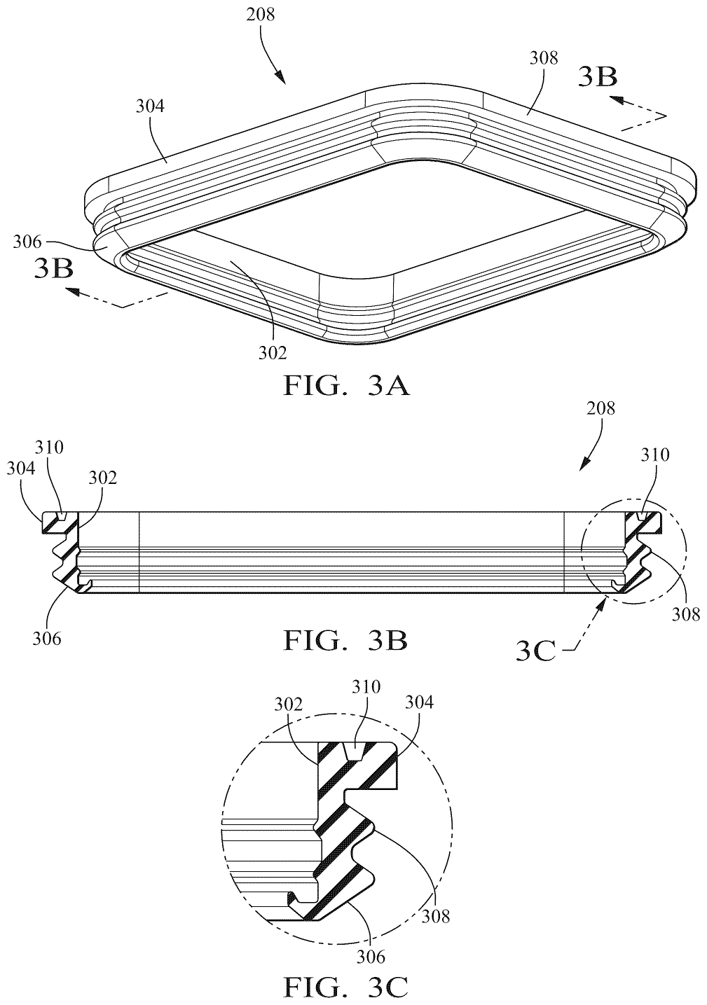

As shown in FIGS. 3A and 3B, the perimeter seal 208 has a seal side wall 302, a seal end wall 304 extending from a first end of the seal side wall 302 in a first direction, and a seal lip 306 extending from a second end of the seal side wall 302 in a second direction opposite the first direction. The seal side wall 302 also defines a sealing rib 308 around the circumference of the perimeter seal 208. The perimeter seal 208 in the illustrated example includes a pair of the sealing rib 308. As best shown in FIG. 3C, the seal end wall 304 defines a groove 310. As shown in FIG. 5, an end segment 506 of a perimeter wall 502 of the outer portion 202 defines a support rib 510 that is received within the groove 310.

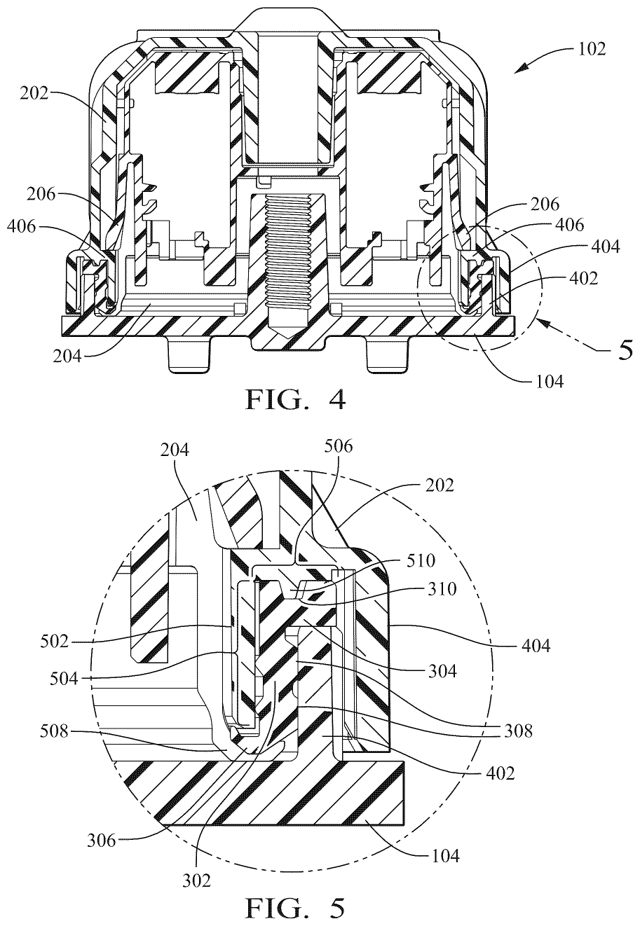

FIG. 4 shows an end cross section view of the sealed connector assembly 100 with the second connector housing 104 in a fully mated condition with the first connector housing 102. As can be seen in FIG. 4, the seal lip 306 of the perimeter seal 208 is secured between the inner portion 204 and the outer portion 202 of the first connector housing 102. The second connector housing 104 is inserted into the first connector housing 102 such that a header wall 402 of the second connector housing 104 is disposed between the perimeter seal 208 and an outer wall 404 of the outer portion 202 of the first connector housing 102. As can further be seen in FIG. 4, the flexible arms 206 of the inner portion 204 of the first connector housing 102 engage a ridge 406 of the outer portion 202 to releasably secure the inner portion 204 within the outer portion 202.

FIG. 5 shows a close-up view of the cross section view of FIG. 4 highlighting the interface between the perimeter seal 208 and the first and second connector housings 102, 104. As shown in FIG. 5, the outer portion 202 has an L-shaped perimeter wall 502 which defines a side segment 504 and an end segment 506. The seal side wall 302 abuts the side segment 504 and the seal end wall 304 abuts the end segment 506. The seal lip 306 overlays an end of the side segment 504 of the perimeter wall 502. The inner portion 204 is disposed inside the perimeter wall 502 and has a connector lip 508 that overlies the seal lip 306 and the end of the side segment 504, The connector lip 508 compresses the seal lip 306 between the connector lip 508 and the end of the side segment 504, thereby retaining the perimeter seal 208 to the outer portion 202 of the first connector housing 102 and inhibiting movement and bunching of the perimeter seal 208 as the second connector housing 104 is mated with the first connector housing 102. The sealing ribs 308 are also resiliently compressed by the contact with the header wall 402. This compression of the sealing ribs 308 is configured to inhibit environmental contaminants, such as water, dust, or other foreign materials, from entering the interior of the first and second connector housings 102, 104.

As shown in FIG. 5, the seal lip 306 is curved and an apex of the seal lip 306 is thicker than the ends of the seal lip 306.

As further shown in FIG. 5, the support rib 510 of the perimeter wall 502 is received within the groove 310 of the perimeter seal 208. The groove 310 and the support rib 510 may extend around the perimeter of the seal end wall 304 and the end segment 506 of the perimeter wall 502. The groove 310 and the support rib 510 cooperate to further inhibit movement and bunching of the perimeter seal 208 as the second connector housing 104 is mated with the first connector housing 102.

FIG. 5 also shows that, when fully mated, a header wall 402 of the second connector housing 104 is in compressive contact with the sealing rib 308. The compressive contact of the header wall 402 with the sealing rib 308 and the seal end wall 304 is configured to further inhibit environmental contaminants from entering the interior of the first and second connector housings 102, 104. The header wall 402 may also be in compressive contact with the seal end wall 304 of the perimeter seal 208 to provide enhanced protection from intrusion of environmental contaminants into the interior of the first and second connector housings 102, 104. Other embodiments may be envisioned in which the header wall 402 of the second connector housing 104 is in compressive contact with the sealing rib 308 but not the seal end wall 304.

The perimeter seal 208 is configured so that it does not “bunch up” as the second connector housing 104 is inserted within the first connector housing 102 when the perimeter seal 208 and the first and second connector housings 102, 104 are in nominal dimensional conditions.

The sealed connector assembly 100 presented herein has been found to resist bunching of the perimeter seal 208 between the first and second connector housings 102, 104 even in maximum material conditions. This provides lower engagement forces when mating the first and second connector housings 102, 104 that enhances ergonomic performance of the sealed connector assembly 100. The sealed connector assembly 100 has also been found to be less susceptible to bunching of the perimeter seal 208 due to variation in the material forming the perimeter seal 208, e.g., variations in oil bleed sealing materials.

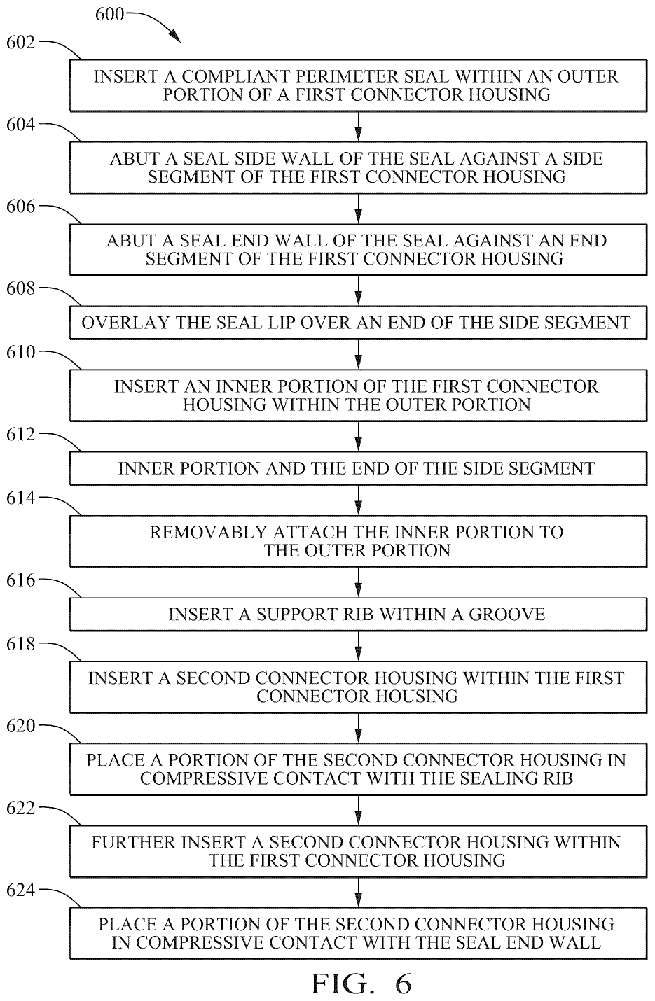

FIG. 6 shows a flow chart of a method of manufacturing a sealed connector assembly including the following steps:

At STEP 602, a compliant perimeter seal is inserted within an outer portion of a connector housing. In some embodiments, this step includes inserting a compliant perimeter seal 208 within an outer portion 202 of a connector housing 102. The perimeter seal 208 has a seal side wall 302, a seal end wall 304 extending from a first end of the seal side wall 302 in a first direction, and a curved seal lip 306 extending from a second end of the seal side wall 302 in a second direction opposite the first direction. The outer portion 202 has a perimeter wall 502 defining a side segment 504 and an end segment 506.

At STEP 604, the seal side wall is abutted against the side segment. In some embodiments, this step includes abutting the seal side wall 302 against the side segment 504.

At STEP 606, the seal end wall is abutted against the end segment. In some embodiments, this step includes abutting the seal end wall 304 against the end segment 506.

At STEP 608, the seal lip is laid over an end of the side segment of the perimeter wall. In some embodiments, this step includes overlaying the seal lip 306 over an end of the side segment 504 of the perimeter wall 502.

At STEP 610, an inner portion of the first connector housing is inserted within a perimeter wall of the outer portion. In some embodiments, this step includes inserting an inner portion 204 of the connector housing 102 within a perimeter wall 502 of the outer portion 202. The inner portion 204 has a connector lip 508 that overlies the seal lip 306 and an end of the side segment 504 of the perimeter wall 502.

At STEP 612, the seal lip is captured between the connector lip and the end of the side segment of the perimeter wall. In some embodiments, this step includes capturing the seal lip 306 between the connector lip 508 and the end of the side segment 504 of the perimeter wall 502 to retain the perimeter seal 208 to the connector housing 102.

At STEP 614, the inner portion is attached to the outer portion. In some embodiments, this step includes removably attaching the inner portion 204 of the connector housing 102 to the outer portion 202 of the connector housing 102 using an attachment feature. In some embodiments, the attachment feature is a flexible arm 206 defined by the inner portion 204 of the connector housing 102 that engages a ridge 406 on the outer portion 202.

At STEP 616, a support rib is inserted within a groove. In some embodiments, the seal end wall 304 defines a groove 310, and the end segment 506 of the perimeter wall 502 defines a support rib 510. In some embodiments, this step includes inserting the support rib 510 within the groove 310.

At STEP 618, a second connector housing 104 is inserted within the connector housing 102. In some embodiments, the connector housing 102 is a first connector housing 102, and the seal side wall 302 defines a sealing rib 308. In some embodiments, this step includes inserting a second connector housing 104 within the first connector housing 102.

At STEP 620, a portion of the second connector housing is placed in compressive contact with the sealing rib of the perimeter seal. In some embodiments, the seal side wall 302 defines a sealing rib 308. In some embodiments, this step includes placing a portion of the second connector housing 104 in compressive contact with the sealing rib 308 of the perimeter seal 208. In some embodiments, the header wall 402 is in compressive contact with the sealing rib 308.

At STEP 622, the second connector housing is further inserted within the first connector housing. In some embodiments, this step includes inserting the second connector housing 104 further within the first connector housing 102.

At STEP 624, a portion of the second connector housing is placed in compressive contact with the seal end wall. In some embodiments, this step includes placing a portion of the second connector housing 104 in compressive contact with the seal end wall 304 of the perimeter seal 208. In some embodiments, the header wall 402 is in compressive contact with the seal end wall 304.

### Discussion of Possible Embodiments

The following are non-exclusive descriptions of possible embodiments of the present invention.

In some aspects, the techniques described herein relate to a sealed connector assembly, including: a compliant perimeter seal having a seal side wall, a seal end wall extending from a first end of the seal side wall in a first direction, and a seal lip extending from a second end of the seal side wall in a second direction opposite the first direction; and a connector housing, further including: an outer portion having a perimeter wall which defines a side segment and an end segment, the seal side wall abutting the side segment and the seal end wall abutting the end segment and the seal lip overlaying at least a portion of an end of the side segment of the perimeter wall, and an inner portion disposed inside the perimeter wall, the inner portion having a connector lip that overlies at least a portion of the seal lip and at least a portion of an end of the side segment of the perimeter wall.

The sealed connector system of the preceding paragraph can optionally include, additionally and/or alternatively any, one or more of the following features, configurations and/or additional components.

In some aspects, the techniques described herein relate to a sealed connector assembly, wherein the seal end wall defines a groove, and the end segment of the perimeter wall defines a support rib received within the groove.

In some aspects, the techniques described herein relate to a sealed connector assembly, wherein the connector lip and the end of the side segment of the perimeter wall are in compressive contact with the seal lip.

In some aspects, the techniques described herein relate to a sealed connector assembly, wherein the perimeter wall is L-shaped.

In some aspects, the techniques described herein relate to a sealed connector assembly, wherein the inner portion of the connector housing is removably attached to the outer portion by an attachment feature.

In some aspects, the techniques described herein relate to a sealed connector assembly, wherein the attachment feature is a flexible arm defined by the inner portion of the connector housing that engages a ridge on the outer portion.

In some aspects, the techniques described herein relate to a sealed connector assembly, wherein the seal side wall defines a sealing rib.

In some aspects, the techniques described herein relate to a sealed connector assembly, wherein the connector housing is a first connector housing, wherein the sealed connector assembly further includes a second connector housing configured to be received in the first connector housing, and wherein the second connector housing is in compressive contact with the sealing rib of the perimeter seal.

In some aspects, the techniques described herein relate to a sealed connector assembly, wherein the second connector housing is in compressive contact with the seal end wall.

In some aspects, the techniques described herein relate to a sealed connector assembly, wherein the perimeter seal is formed of a silicone-based rubber material, the first connector housing is formed of a polymeric material, and the second connector housing is formed of a metallic material.

In some aspects, the techniques described herein relate to a sealed connector assembly, wherein the first connector housing is configured to contain a plurality of electrical terminals, and the second connector housing is configured to contain a plurality of mating electrical terminals.

In some aspects, the techniques described herein relate to a sealed connector assembly, wherein the seal end wall is generally flat on one side and extends substantially perpendicularly from the seal side wall.

In some aspects, the techniques described herein relate to a sealed connector assembly, wherein the seal lip curved.

In some aspects, the techniques described herein relate to a sealed connector assembly, wherein an apex of the seal lip is thicker than ends of the seal lip and wherein the seal end wall is thicker than the seal lip.

In some aspects, the techniques described herein relate to a method of manufacturing a sealed connector assembly, including: inserting a compliant perimeter seal within an outer portion of a first connector housing, the perimeter seal having a seal side wall, a seal end wall extending from a first end of the seal side wall in a first direction, and a curved seal lip extending from a second end of the seal side wall in a second direction opposite the first direction, the outer portion having a perimeter wall defining a side segment and an end segment; abutting the seal side wall against the side segment; abutting the seal end wall against the end segment; overlaying the seal lip over an end of the side segment of the perimeter wall; and inserting an inner portion of the first connector housing within a perimeter wall of the outer portion, the inner portion having a connector lip that overlies the seal lip and an end of the side segment of the perimeter wall; capturing the seal lip between the connector lip and the end of the side segment of the perimeter wall to retain the perimeter seal to the first connector housing.

The method of the preceding paragraph can optionally include, additionally and/or alternatively any, one or more of the following features, configurations and/or additional components.

In some aspects, the techniques described herein relate to a method, further including: removably attaching the inner portion of the connector housing to the outer portion using an attachment feature.

In some aspects, the techniques described herein relate to a method, wherein the attachment feature is a flexible arm defined by the inner portion of the connector housing that engages a ridge on the outer portion.

In some aspects, the techniques described herein relate to a method, wherein the seal end wall defines a groove, and the end segment of the perimeter wall defines a support rib, wherein the method additionally includes inserting the support rib within the groove.

In some aspects, the techniques described herein relate to a method, wherein the connector housing is a first connector housing, wherein the seal side wall defines a sealing rib, and wherein the method additionally includes: inserting a second connector housing within the first connector housing and placing a portion of the second connector housing in compressive contact with the sealing rib of the perimeter seal.

In some aspects, the techniques described herein relate to a method, wherein the method additionally includes further inserting the second connector housing within the first connector housing and placing a portion of the second connector housing in compressive contact with the seal end wall.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A sealed connector assembly, comprising:
a compliant perimeter seal having a seal side wall, a seal end wall extending from a first end of the seal side wall in a first direction, and a seal lip extending from a second end of the seal side wall in a second direction opposite the first direction; and
a connector housing, further comprising:
an outer portion having a perimeter wall which defines a side segment and an end segment, the seal side wall abutting the side segment and the seal end wall abutting the end segment and the seal lip overlaying at least a portion of an end of the side segment of the perimeter wall, and
an inner portion disposed inside the perimeter wall, the inner portion having a connector lip that overlies at least a portion of the seal lip and at least a portion of an end of the side segment of the perimeter wall.

2. The sealed connector assembly according to claim 1, wherein the seal end wall defines a groove, and the end segment of the perimeter wall defines a support rib received within the groove.

3. The sealed connector assembly according to claim 1, wherein the connector lip and the end of the side segment of the perimeter wall are in compressive contact with the seal lip.

4. The sealed connector assembly according to claim 1, wherein the perimeter wall is L-shaped.

5. The sealed connector assembly according to claim 1, wherein the inner portion of the connector housing is removably attached to the outer portion by an attachment feature.

6. The sealed connector assembly according to claim 5, wherein the attachment feature is a flexible arm defined by the inner portion of the connector housing that engages a ridge on the outer portion.

7. The sealed connector assembly according to claim 1, wherein the seal side wall defines a sealing rib.

8. The sealed connector assembly according to claim 7, wherein the connector housing is a first connector housing, wherein the sealed connector assembly further comprises a second connector housing configured to be received in the first connector housing, and wherein the second connector housing is in compressive contact with the sealing rib of the perimeter seal.

9. The sealed connector assembly according to claim 8, wherein the second connector housing is in compressive contact with the seal end wall.

10. The sealed connector assembly according to claim 8, wherein the perimeter seal is formed of a silicone-based rubber material, the first connector housing is formed of a polymeric material, and the second connector housing is formed of a metallic material.

11. The sealed connector assembly according to claim 8, wherein the first connector housing is configured to contain a plurality of electrical terminals, and the second connector housing is configured to contain a plurality of mating electrical terminals.

12. The sealed connector assembly according to claim 1, wherein the seal end wall is generally flat on one side and extends substantially perpendicularly from the seal side wall.

13. The sealed connector assembly according to claim 1, wherein the seal lip curved.

14. The sealed connector assembly according to claim 13, wherein an apex of the seal lip is thicker than ends of the seal lip and wherein the seal end wall is thicker than the seal lip.

15. A method of manufacturing a sealed connector assembly, comprising:
inserting a compliant perimeter seal within an outer portion of a first connector housing, the perimeter seal having a seal side wall, a seal end wall extending from a first end of the seal side wall in a first direction, and a curved seal lip extending from a second end of the seal side wall in a second direction opposite the first direction, the outer portion having a perimeter wall defining a side segment and an end segment;
abutting the seal side wall against the side segment;
abutting the seal end wall against the end segment;
overlaying the seal lip over an end of the side segment of the perimeter wall;
inserting an inner portion of the first connector housing within a perimeter wall of the outer portion, the inner portion having a connector lip that overlies the seal lip and an end of the side segment of the perimeter wall; and
capturing the seal lip between the connector lip and the end of the side segment of the perimeter wall to retain the perimeter seal to the first connector housing.

16. The method of claim 15, further comprising:
removably attaching the inner portion of the connector housing to the outer portion using an attachment feature.

17. The method according to claim 16, wherein the attachment feature is a flexible arm defined by the inner portion of the connector housing that engages a ridge on the outer portion.

18. The method of claim 15, wherein the seal end wall defines a groove, and the end segment of the perimeter wall defines a support rib, wherein the method additionally comprises inserting the support rib within the groove.

19. The method of claim 15, wherein the connector housing is a first connector housing, wherein the seal side wall defines a sealing rib, and wherein the method additionally comprises:
inserting a second connector housing within the first connector housing; and
placing a portion of the second connector housing in compressive contact with the sealing rib of the perimeter seal.

20. The method of claim 19, wherein the method additionally comprises:
further inserting the second connector housing within the first connector housing; and
placing a portion of the second connector housing in compressive contact with the seal end wall.
